(19) United States
(12) Patent Application Publication
(10) Pub. No.: US 2002/0049600 A1
(43) Pub. Date: Apr. 25, 2002

(54) Speech processor apparatus and system

(75) Inventors: Lauren L'Esperance, Arlington, MA (US); Alan Schell, Hopkinton, MA (US)

Correspondence Address: BROMBERG & SUNSTEIN LLP, 125 SUMMER STREET, BOSTON, MA, 02110-1618, US

(73) Assignee: Lernout & Hauspie Speech Products N.V., Ieper (BE)

(21) Appl. No.: 09/854,137

(22) Filed: May 11, 2001

Related U.S. Application Data
(60) Provisional application No. 60/203,548, filed on May 12, 2000.

(51) Int. Cl. G10L 21/00

(52) U.S. Cl. 704/277

(57) ABSTRACT

An audio recorder for interfacing with a speech recognition systems includes a microphone having an open front port that senses an audio signal and a closable back port which, when open, senses an audio signal. The microphone also produces an output signal representative of the audio sensed by the microphone. The recorder further includes a mode selector switch having two positions. The first position provides a close-talking mode in which the back port is open so that audio signals are sensed through both the front port and the back port to reduce representation of environmental noise in the output signal. The second position provides a conference-talking mode in which the back port is closed and audio signals are sensed through the front port only and environmental noise is not reduced. In accordance with another aspect of the present invention, a computer user interface provides access to an audio recorder and includes a communication module that generates an access request to a file manager of the audio recorder and an access interface coupled to the communication module. The access interface includes display regions that specify an audio recorder that may contain the audio files, an identity of a speaker who recorded the audio file, and an acoustic environment in which the audio file was recorded.

The present application claims priority from provisional application Serial No. 60/203,548 filed May 12, 2000 and hereby incorporated herein by reference.

### FIELD OF THE INVENTION

The invention generally relates to automatic speech recognition, and more particularly, to a portable peripheral recorder interface for a speech recognition system.

### BACKGROUND ART

Tape recorders for recording memos, letters and other documents are well known. Hand held recording devices, that allow a user to dictate a document while traveling, are also known. These compact recorders make mobile recording convenient and save time.

Automatic speech recognition systems are an emerging technology in which a computer is programmed to recognize a spoken word by translating an audio input of the word into a digitalized version. The digitalized version can be compared to a version stored in the system's memory.

Recording devices incorporating speech recognition techniques may be compact for mobile use. However, access to information stored in such devices is limited.

### SUMMARY OF THE INVENTION

A representative embodiment of the present invention includes an audio recorder for interfacing with a speech recognition system. The recorder includes a microphone having an open front port that senses an audio signal and a closable back port which, when open, senses an audio signal. The microphone also produces an output signal representative of the audio signal sensed by the microphone. The recorder further includes a mode selector switch having two positions. The first position provides a close-talking mode in which the back port is open so that audio signals are sensed through both the front port and the back port to reduce representation of environmental noise in the output signal. The second position provides a conference-talking mode in which the back port is closed and audio signals are sensed through the front port only, so that environmental noise is not reduced.

In accordance with another aspect of the invention, the output signal may be compressed by the recorder, and the second position of the mode selector switch may cause greater compression than the first position. Similarly, the output signal may be amplified by the recorder, and the second position of the mode selector switch may cause greater amplification than the first position.

In a further embodiment of the invention, an audio recorder for interfacing with a speech recognition system has a microphone that produces an output signal representative of an input audio signal. The audio recorder also includes a recording file memory for storing recording files and a record control that causes the recorder to create a new recording file for storing data representative of the output signal. The record control may also cause the recorder to begin storing data in the recording file. In this embodiment, a stop control causes the recorder to stop storing data in the recording file and also ends the recording file.

In accordance with another embodiment of the invention, an audio recorder for interfacing with a speech recognition system includes an internal microphone that produces an output signal representative of an input audio signal and a jack for an external microphone. The external microphone disables the internal microphone when plugged into the jack, and allows the external microphone to produce the output signal representative of an input audio signal. The audio recorder also includes a recording file recorder that stores data representative of the output signal as well as an indication of the microphone used to produce the output signal.

In another embodiment of the invention, an audio recorder for interfacing with a speech recognition system has a housing containing the recorder. The housing includes a microphone that produces an output signal representative of an input audio signal and a recorder interface display that displays information regarding the current state of the recorder. The recorder may have a speech recognition system interface connection that allows the user to change the language of the information displayed

In a further embodiment, an audio recorder for interfacing with a speech recognition system includes a microphone that produces an output signal representative of an input audio signal and a recording file recorder that stores data representative of the microphone output signal. An external interface allows an external recording file containing data representative of an audio signal to be input to the recorder for storage, and a recording file manager allows a user to store and manage a plurality of recording files in the recorder. The recorder may also include a recording file player that produces an audible output for the user representative of a user selected recording file and the recording file player may have a text-to-speech module so that an external recording file may contain text. The external recording file may be an e-mail message or an alphanumeric paging message. The user may respond to the e-mail message audibly, via the microphone, transcribe the response, and attached it to the e-mail message. Similarly, the user may record a recording file for insertion into an existing recording file and the recording file manager may allow the recording files to be linked together for common processing.

In accordance with another aspect of the present invention, a computer user interface provides access to an audio recorder and includes a communication module that generates an access request to a file manager of the audio recorder, and an access interface coupled to the communication module. The access interface includes display regions that specify an audio recorder that may contain an audio file or folder, an identity of a speaker who recorded the audio file, and an acoustic environment in which the audio file was recorded. In a further embodiment, the access interface may include display region to specify the type of microphone used to record the audio file, a display region to specify a retrieval method for the audio files, and a display region that notifies a user of a file transfer status.

In still further embodiments, a file transfer interface is coupled to the communication module to transfer files or folders between an audio recorder and a user computer. The file transfer interface may include display regions to specify that at least one audio file be transferred, that at least one audio file be transcribed, and that at least one audio file be delivered to a third application. The file transfer interface may also include a display region to specify one of a plurality of delivery methods for a transferred file.

In another embodiment of the invention, a user preference interface coupled to the communication module is used to configure an audio recorder. The user preference interface may include an option to conceal an audio file or folder, compress an audio file, edit or add an audio file, or create an audio file or folder. Similarly, the user preference interface may provide options to transcribe an audio file or transcribe an audio file with human post editing. The user preference interface may further include display regions to specify a language in which menus are displayed on the audio recorder.

In accordance with another aspect of the invention, a system for managing audio files on an audio recorder includes an audio recorder to record an audio file, a communication module that generates an access request to a file manager of the audio recorder, and an access interface. The access interface is coupled to the communication module and includes display regions that specify an audio recorder that may contain an audio file, an identity of a speaker who recorded the audio file, and an acoustic environment in which the audio file was recorded.

In other embodiments, the system may include an audio recorder having a microphone with an open front port that senses an audio signal and a closable back port which, when open, senses an audio signal. The microphone produces an output signal representative of the audio signal sensed by the microphone. The audio recorder may also have a mode selector switch having a first position for a close-talking mode. In the close-talking mode, the back port is open so that audio signals are sensed through both the front port and the back port, and representation of environmental noise in the output signal is reduced. The switch also has a second position for a conference-talking mode in which the back port is closed. When the back port is closed, audio signals are sensed through the front port only and environmental noise is not reduced.

In still further embodiments of the invention, the system may include a file transfer interface coupled to the communication module to transfer files between an audio recorder and a user computer. In other embodiments of the invention, the computer user interface includes a user preference interface coupled to the communication module.

### BRIEF DESCRIPTION OF THE DRAWINGS

The present invention will be more readily understood by reference to the following detailed description taken with the accompanying drawings, in which:

FIG. 1 illustrates a front view of an audio recorder in accordance with one aspect of the present invention;

FIG. 2 illustrates a rear view of the embodiment of FIG. 1;

FIG. 3 illustrates a first side view of the embodiment of FIG. 1;

FIG. 4 illustrates a second side view of the embodiment of FIG. 1;

FIG. 5 illustrates a top view of the embodiment of FIG. 1;

FIG. 6 illustrates a bottom view of the embodiment of FIG. 1;

FIG. 7 illustrates a system in accordance with another aspect of the present invention;

FIG. 8 illustrates an access interface by which files in an audio recorder may be accessed in accordance with a further aspect of the present invention;

FIGS. 9(a) and 9(b) illustrate display regions of the embodiment of FIG. 8 for notifying a user of the status of a retrieval request;

FIG. 10 illustrates a display region of the embodiment of FIG. 8 by which a microphone may be specified;

FIGS. 11(a) and 11(b) illustrate display regions of the embodiment of FIG. 8 that prompt a user to change a microphone field;

FIG. 12 illustrates a file transfer interface by which files may be downloaded in accordance with another aspect of the present invention;

FIG. 13 illustrates a display region of the embodiment of FIG. 12 whereby a file may be uploaded to an audio recorder;

FIG. 14 illustrates a user preference interface by which a user may configure an audio recorder;

FIG. 15 illustrates a display region of the embodiment of FIG. 14 whereby recording preferences may be specified;

FIG. 16 illustrates a display region of the embodiment of FIG. 14 whereby an audio file or folder may be concealed in an audio recorder;

FIG. 17 illustrates a display region of the embodiment of FIG. 14 whereby an audio file or folder may be created in an audio recorder;

FIG. 18 illustrates a display region of the embodiment of FIG. 14 whereby an audio file or folder may be edited; and

FIG. 19 illustrates a display region of the embodiment of FIG. 14 whereby an audio file may be added in an audio recorder.

### DETAILED DESCRIPTION OF SPECIFIC EMBODIMENTS

Preferred embodiments of the present invention are directed to an audio recorder in which audio files may be stored for subsequent manipulation by a user at a computer interface, for example, for a speech recognition system.

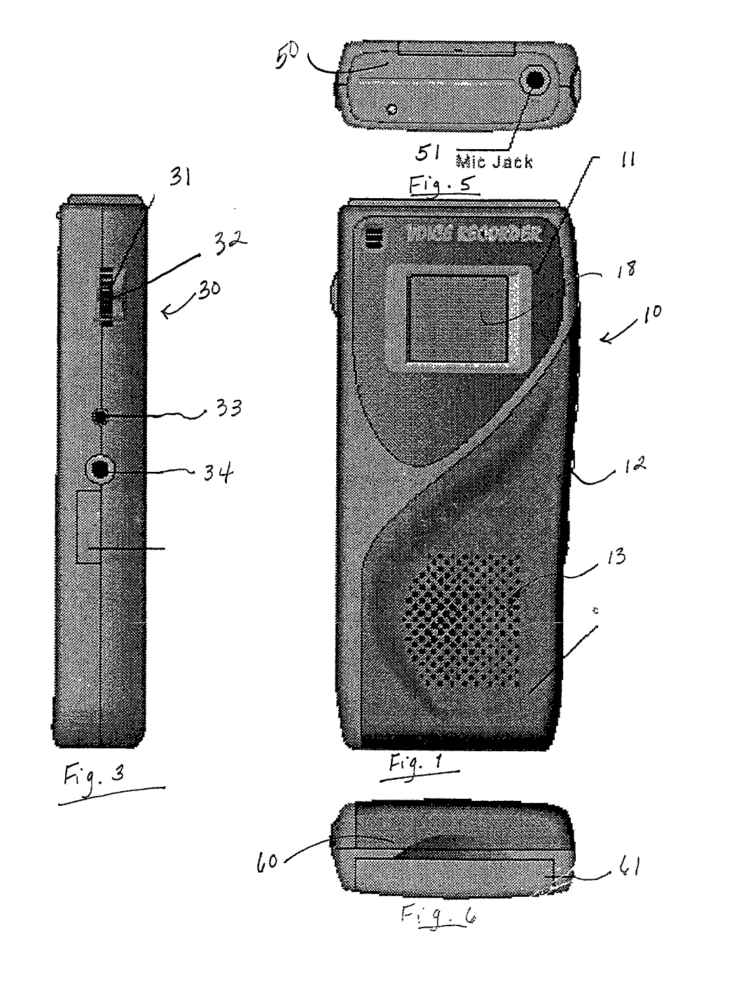

FIGS. 1-6 illustrate an audio recorder in accordance with one aspect of the present invention. In FIG. 1, an audio recorder 10 includes a housing 11 with a front panel 12. The front panel 12 has an open front port 13 lending access to an internal microphone (not shown). The internal microphone is capable of sensing an audio input signal and of producing an output signal representative of the input signal. The front panel 12 also includes a recorder interface display 18 that displays information regarding the current state of the recorder.

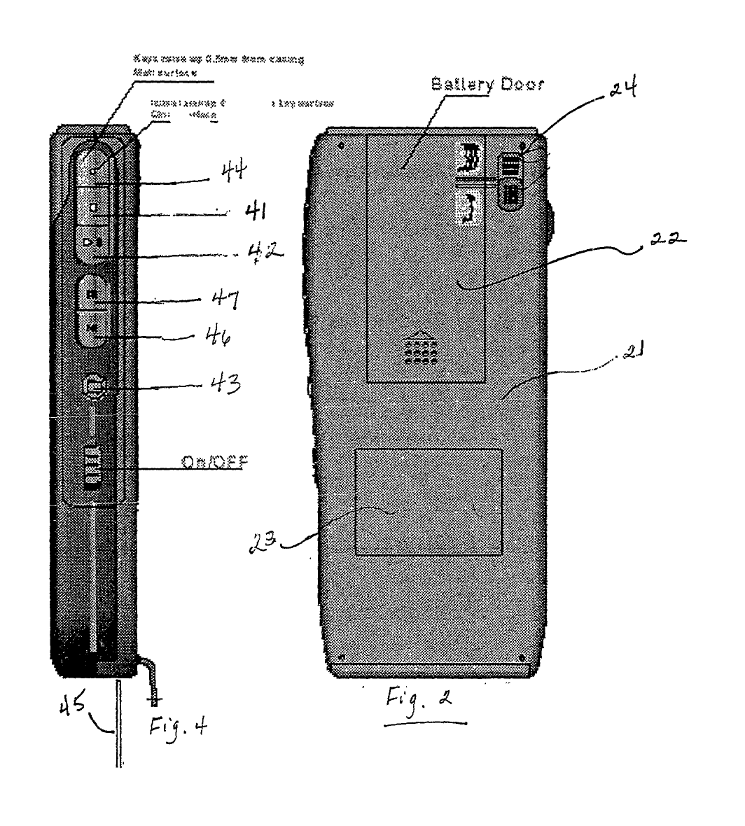

FIG. 2 illustrates that the housing 11 has a rear panel 21. The rear panel 21 includes a battery door 22 by which batteries are inserted and removed from the audio recorder, and a back port 23. The rear panel 21 also includes a mode selector switch 24 having a first position by which a close-talking mode is activated. In the first position, the back port 23 is open so that audio signals are sensed through both the front port 13 and the back port 23 to reduce representation of environmental noise in the output signal. The mode selector switch 24 also has a second position by which a conference-talking mode is activated. In the conference-talking mode, the back port 23 is closed and audio signals may be sensed only through the open front port 13, and environmental noise is not reduced. Thus the second position of the mode selector switch causes greater amplification of an output signal than the first position. The second position of the mode selector switch also causes greater compression of an output signal than the first position.

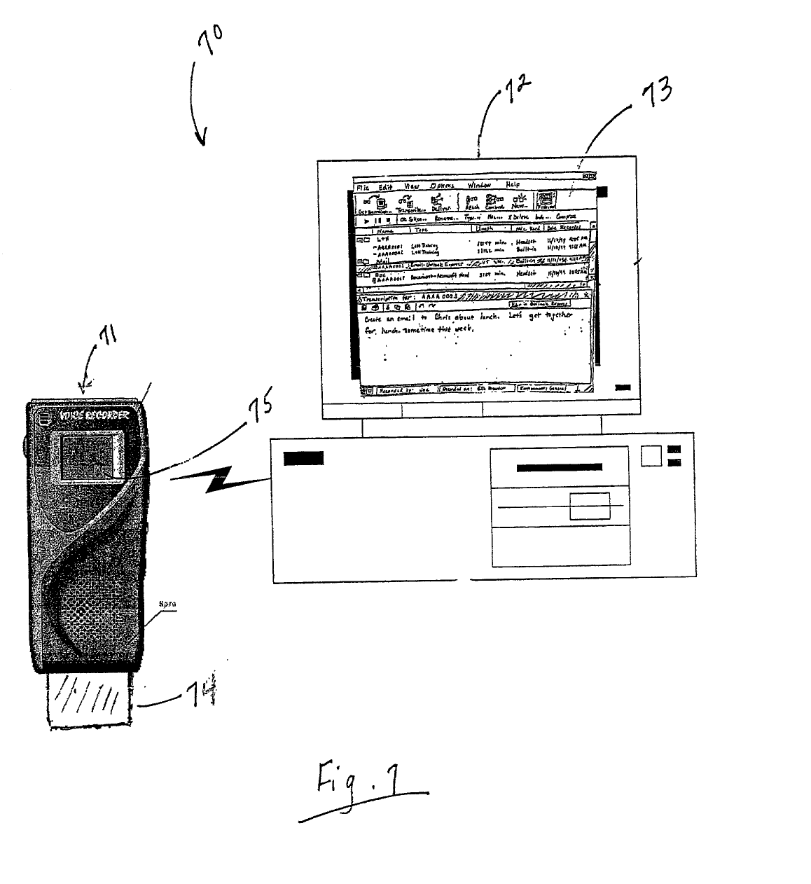

Additional features of the audio recorder are illustrated in FIGS. 3-6. A first side panel 30 provides a menu wheel 31 by which a user may select from a plurality of menu options. Features and options of the audio recorder are accessed through pushing a nub 32 on the menu wheel 31. In this embodiment, there are two levels of the menu, OPTNS and SETUP. Persons skilled in the art, however, will realize that other levels may be added. Advancing between choices is done through turning the wheel 31, and selecting an option is accomplished by pressing the nub 32 on the wheel 31. While a user is viewing a menu screen of the recorder interface display 18, the user may toggles between OPTNS and SETUP by turning the wheel 31. Pressing the nub 32 allows the user to select a menu choice and advance to the next choice in a menu level. After making a selection and advancing through a particular level of the menu, continued turning of the wheel 31 would result in travelling through all the menu choices of the selected level (OPTNS or SETUP) again. Pressing the nub 32 at any choice stops the searching at this choice. Pressing the stop button 41 (see FIG. 4) exits out of menu mode, and cycling through all the choices down either the OPTNS or SETUP level will also exit out of menu mode.

Through the OPTNS level of the menu, a user may access an ERASE option. In this embodiment, there are four ERASE modes in the audio recorder 10. These modes allow a user to delete all files in a folder, delete one file, delete a section of a file, or erase all contents of an internal or external memory. After each erasure, a confirmation screen is given. The last file or folder used is the one displayed on the recorder interface display 18, unless the file or folder was from an external card and the card was removed. A folder is erased by pressing the nub 32 when the folder is displayed on the recorder interface display 18. Similarly, a file is erased by displaying the file and pressing the nub 32. Alternatively, when a file is displayed, the play/pause button 42 (see FIG. 4) may be pressed to hear the file. Pressing the play/pause button 42 again will stop playback. Playback continues until the play/pause button 42 is pressed again, the stop button 41 is pressed, YES/NO is selected on the recorder interface display 18, or the file has played to completion, whichever occurs first. If the user presses the play/pause button 42, and then presses the nub 32 to select YES, then play will stop, and the file will be erased.

A segment within a file may be erased while listening to a recording. The user will press the index button 43 (shown in FIG. 4) first at the point in the file he or she would like to begin the erasure, and again at a point in the file he or she would like to end the erasure. During playback, if the user presses the play/pause button 42 anywhere between the two index marks, and then goes into menu mode and does an erase, everything between the index marks will be deleted. The play/pause button 42 may also be pressed to hear the segment marked for deletion. The segment will play until completion, until the play/pause button 42 is pressed again, of until the stop button 41 is pressed.

A user may also wish to edit a recording and this can be done by getting to a particular point in the recording and overwriting or inserting information at that point. The user toggles through the menu using the menu wheel 31 and chooses the EDIT option by pressing the nub 32. Options to insert or overwrite will appear on the recorder interface display 18, and the user may choose one or the other by using the menu wheel 31 and pressing the nub 32.

Through the SETUP level of the menu, a mode may be chosen whereby the audio recorder 10 will turn itself on for recording when it is configured with the appropriate sound level, and off when the amplitude goes below this level. If this option is chosen, the user will be walked through a level setting procedure. During the level setting procedure, the user chooses the VOICE START option from the SETUP menu using the menu wheel 31 and nub 32. Voice level setting is required for two features, voice start recording and the audio recorder internal gain control setting. The audio recorder has an internal gain level that may be set in lieu of AGC (automatic gain control). (A problem with AGC is that there is an abrupt change in signal waveforms when it turns on. When the speaker is silent, the AGC stops working, then begins to work again as user begins to speak again. It is desired to have a gain setting procedure to set a constant gain level for the audio recorder.) The user accesses a mode where he or she speaks at a volume level that is normal for dictating. The audio recorder uses this speech to determine an appropriate level for recording, and this is the gain level used. If a fixed gain value level is selected for all users, it would be problematic for both very soft speakers and very loud speakers. If the user does not set the voice level, the audio recorder will default to an AGC algorithm that is favorable for general speech. For one specific embodiment, the recorder may be programmed to respond to two acceptable gain levels.

The first screen seen on the recorder interface display 18 during the voice level set procedure instructs the user to press the nub 32. The user is then instructed to press the record button 44 (seen in FIG. 4) and to speak. After ten seconds has passed, the user is instructed to press the stop button 41. The audio recorder will start beeping at the ten second mark, and a stop icon will appear on the recorder interface display 18. At this point enough speech will have been measured to set the gain. A confirmation screen will confirm that a voice level has been set and the recorder interface display 18 will display a number corresponding to the set level.

In this embodiment, the audio recorder has a four digit ID that is set through the SETUP level. This four digit ID is used for naming files to be saved on the audio recorder. File names include a four digit ID, plus four more numeric digits. Each time a new file is named, a four digit counter is incremented. If a particular recorder is set with the ID “JANE”, the first file ever recorded will be named JANE0001, the 27^{th} file recorded, JANE0027, etc.

The procedure for setting the ID is basically the same procedure used to change the time registered by the audio recorder, the date registered by the audio recorder and folder names. The user chooses the SET ID (or SET TIME, SET DATE, etc.) option from the menu using the wheel 31 and nub 32. The recorder interface display 18 displays a position for a first character of the file ID, marked by a blinking underscore symbol, for the first character. The menu wheel 31 is used to select the desired number or letter and the nub 32 is pressed when done. The user repeats this procedure for the remaining character positions. When the user is finished, they press in the nub 32 to SAVE their choice. Otherwise, they use the menu wheel 31 to select BACK, and then press the nub 32 to begin setting the ID again.

If the audio recorder ID is changed, then a file counter should begin counting from 0001 again. If for some reason a new recording is generated with the same number as a previous one already stored on the system, then the new recording will take the place of the old recording. (For example, a user having the identification AAAA records two files, AAAA0001 and AAAA0002, and saves them on the recorder. If the user changes the ID to BBBB, then changes it back to AAAA, the first file recorded for AAAA will be AAAA0001, a file already existing on the recorder.)

Any of the folder names on the recorder may be changed as well. Upon selecting an appropriate option, the folder that was last used will be displayed to the user, and at this point the name may be changed in the exact same manner as the ID is changed.

The audio recorder 10 may have an internal memory that can be formatted such that all data, including any ID setting or folder renaming, will be lost and all recorder settings will revert back to a factory default setting. The internal memory may include a plurality of files or folders. In one embodiment, the internal memory contains a folder for training the speech recognizer to recognize new vocabulary. In this embodiment, a user repeats the new word or phrase into the microphone and the information is stored in the training folder or file. The word may subsequently entered into the speech recognition system on a computer workstation.

The audio recorder also uses external memory cards 45 that are inserted in a card door 61 (seen more clearly in FIG. 6) for additional memory capability. Selecting FORMAT from the SETUP level of the menu will format the card currently inserted in the audio recorder. If a card that has never been formatted is inserted, then after power-up, a “format card” screen of the recorder interface display 18 will appear and the user may choose to format the card.

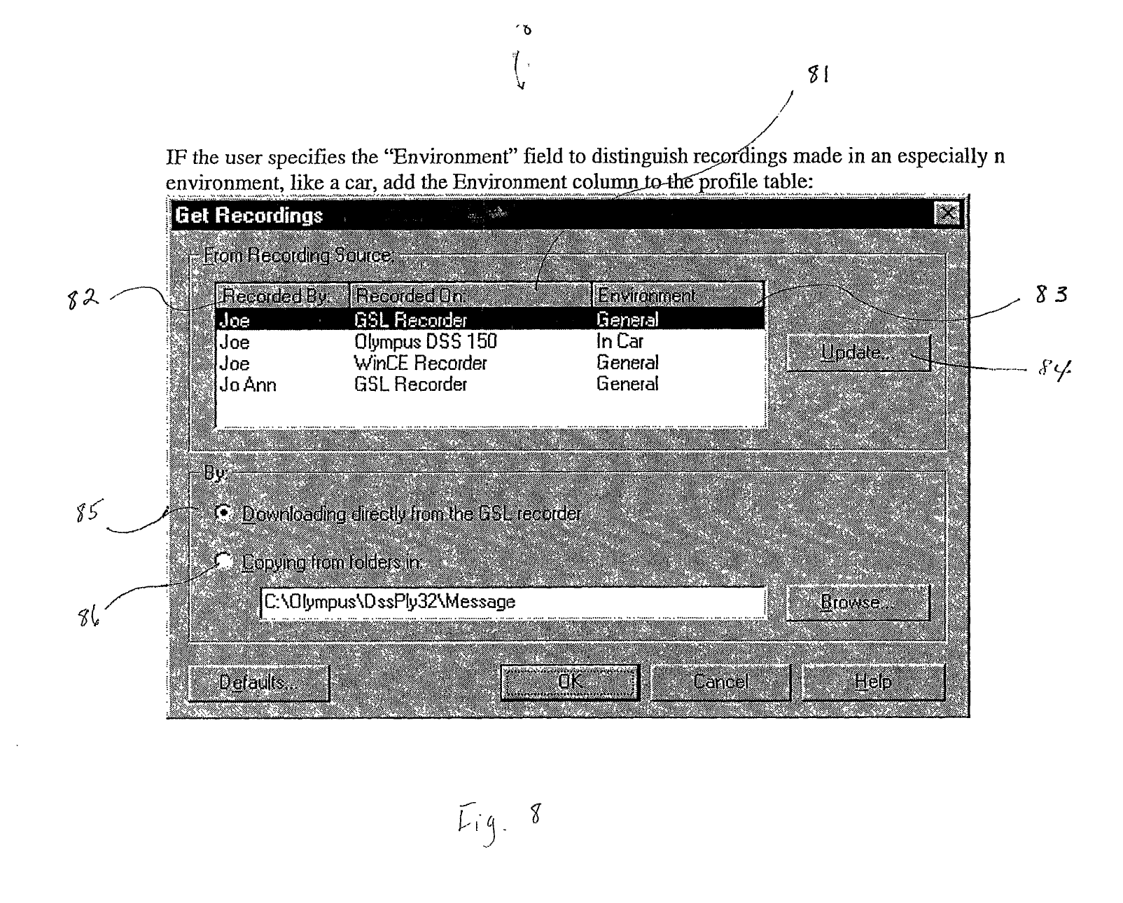

FIG. 3 illustrates that, in the embodiment of FIGS. 1-6, the first side panel 30 of the housing 11 also includes a DC power jack 33 and an ear jack 34 for connection to a headset. The audio recorder also has a fast forward button 46 and a fast backward button 47 (see FIG. 4). FIG. 5 illustrates that a top panel 50 of the housing 11 includes a jack for connecting the audio recorder 10 to an external microphone.

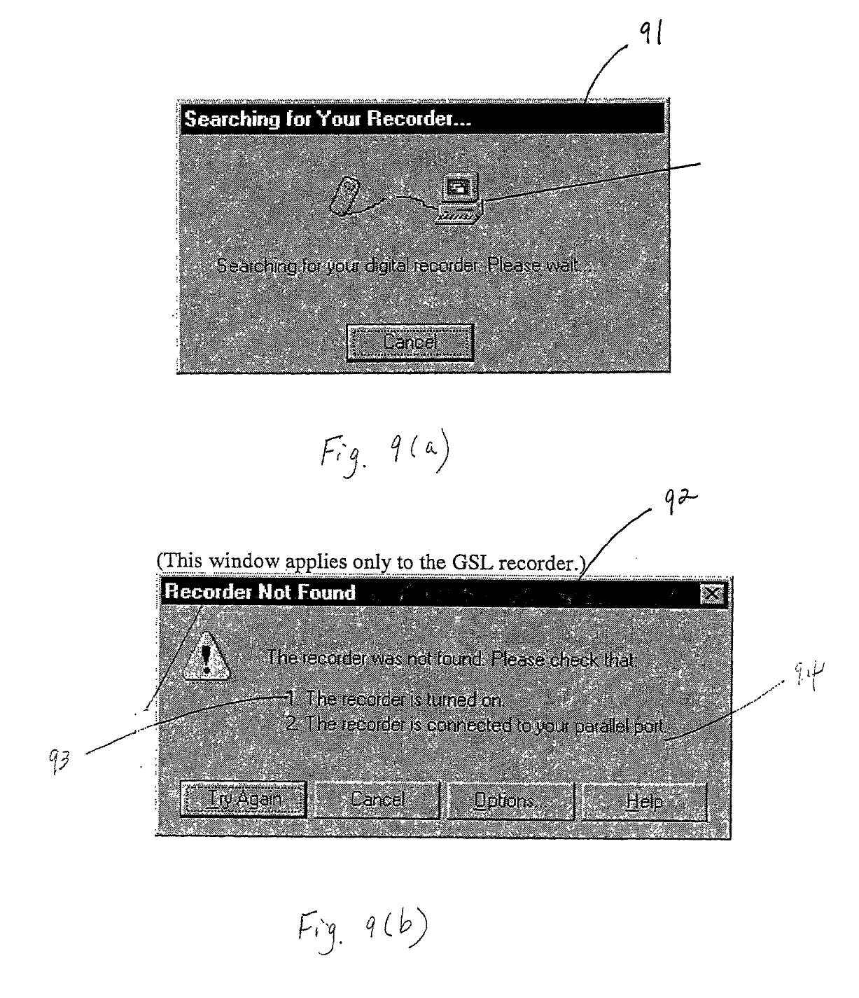

FIG. 7 illustrates a system in accordance with another aspect of the present invention. The system includes an audio recorder 71 in communication with a communication module that is resident on a personal computer 72 that has been equipped with speech recognition technology. The audio recorder 71 has an internal memory (not shown) and may use an external memory card 74 for added memory capacity as discussed with respect to FIGS. 1-6. The personal computer 72 includes a computer user interface 73 by which files in the audio recorder may be accessed. During communication with the personal computer, the buttons on this embodiment of the audio recorder are inoperable and the audio recorder should be turned off.

Through the system 70, a user may perform any one of a plurality of operations on the audio recorder through the interface 73 of the personal computer 72. A user may: download contents of a particular folder from internal memory of the audio recorder 71; download contents of a particular folder from the external card 74 of the audio recorder 71; download contents of all folders from the internal memory; download contents of all folders from the external memory card 74; or download the contents of all folders from the audio recorder 71(the contents both the internal memory and the external memory card 74). When a file is downloaded, the following information will also be downloaded: filename (ID+4 digit number), date/time of creation, folder that the file is from, and any index marks.

Similarly, the user may erase the contents of all folders in the internal memory; erase contents of all folders in the external memory card; erase contents of a particular (single) folder, either in the internal memory or on the external memory card 74; erase a single file in either memory; or erase the contents of the internal or external memory separately. A user may also change the name of any of the folders in the internal memory of the audio recorder 71 or change the name of any folders saved on the external memory card 74.

The ID of the audio recorder 71 may be set using the computer user interface 73, as well as the time registered by the audio recorder 71 and the format to display the time. The date registered on the audio recorder 71 may be set through the computer user interface 73 and the language used on the recorder interface 75 may be selected. The recorder interface 75 may display information in English, French, Dutch, German, Spanish, or any other language.

Additionally, the user may choose which folders are displayed on the recorder interface 75 through the computer user interface 73 of the personal computer 72. The user may also download a new file to the audio recorder 71, and reset the recorder to accommodate the new file, if necessary.

The audio recorder 71 may have files uploaded to it from the personal computer 72. In this embodiment, these files will be limited to filenames of 8 characters, and will have up to 128 characters in an information field. The audio recorder will have the capability to display the filename of the files. With this feature, email may be read with TTS, compressed to the audio recorder format, and downloaded to the audio recorder for later listening. Further, a user may audibly respond to the e-mail message via the microphone, and the response may be transcribed to text and attached to the e-mail message.

Files can be given an 8 character name that is descriptive enough to be distinguishable for each application. Also, the 128 character text field can be used to put in detailed information such as a subject's full name and identification number. A person making a recording can find the correct file through the file name and/or the text field and begin dictating. Later, these files can be given to a transcription service to be transcribed with voice recognition and corrected for errors. The files dictated and transcribed will automatically have the correct filename information and the correct text field information.

The audio recorder in this embodiment is able to support at least the following languages on the recorder interface display 75: English, French, Dutch, German, and Spanish. The language should be selected through the computer user interface 73 of the personal computer 72, so that if a user selects a particular language, then all corresponding displays will be in that language. In this way, multiple variants of the audio recorder 71 are unnecessary. Instead of storing all of the information for all languages on the audio recorder 71, it should be stored on the personal computer 72 and written to the audio recorder 71.

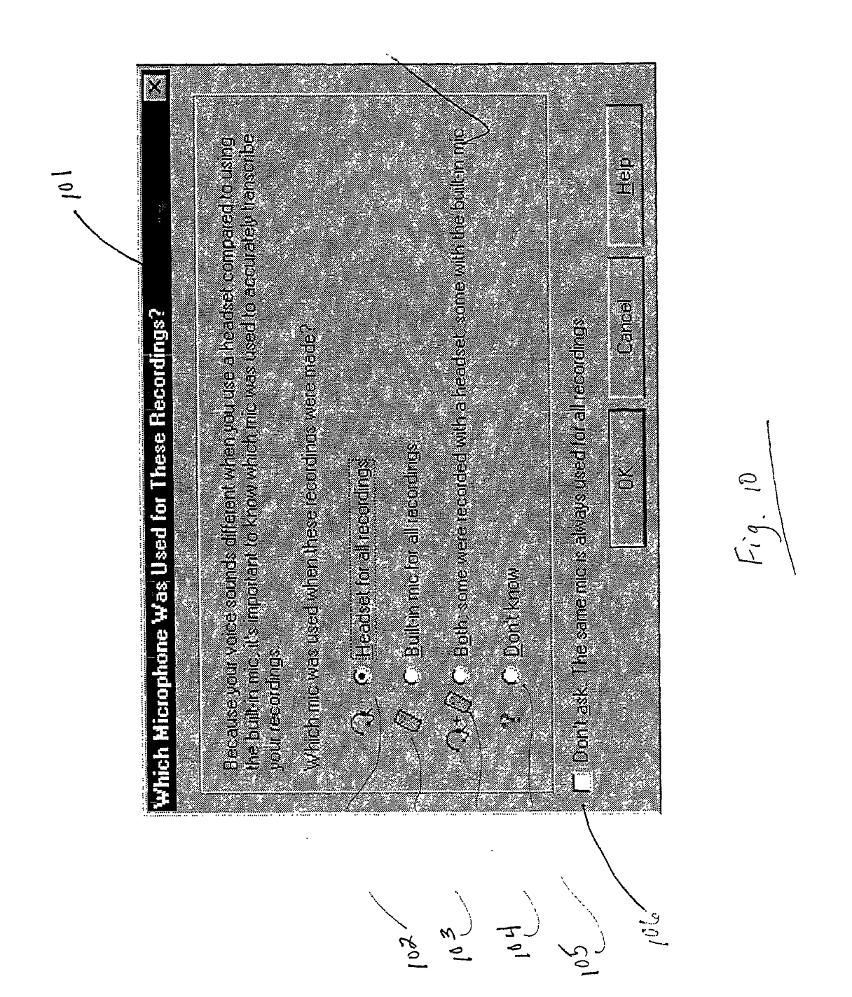

FIG. 8 illustrates an access interface for a computer workstation by which files may be retrieved from an audio recorder in accordance with a further aspect of the present invention. The access interface 80 contains a display region for retrieving files from an audio recorder. The access interface also includes a display region that specifies the audio recorder that contains the audio files 81, a display region that specifies the identity of the speaker that recorded the audio file 82, and a display region that specifies the environment in which the recording was made 83. In this embodiment, the user's name, the type of recorder used, and the environment in which a recording is made (such as “in car” or “general”), designates a user profile that enables a speech recognition device to produce a more accurate transcription of the audio file. The access interface also includes an update button 84 whereby a user may create or change a profile. Further, the access interface provides a user with several retrieval options. Files may be downloaded directly from an audio recorder by selecting the download option 85 or copied from any one of a plurality of audio recorders by selecting the copy option 86.

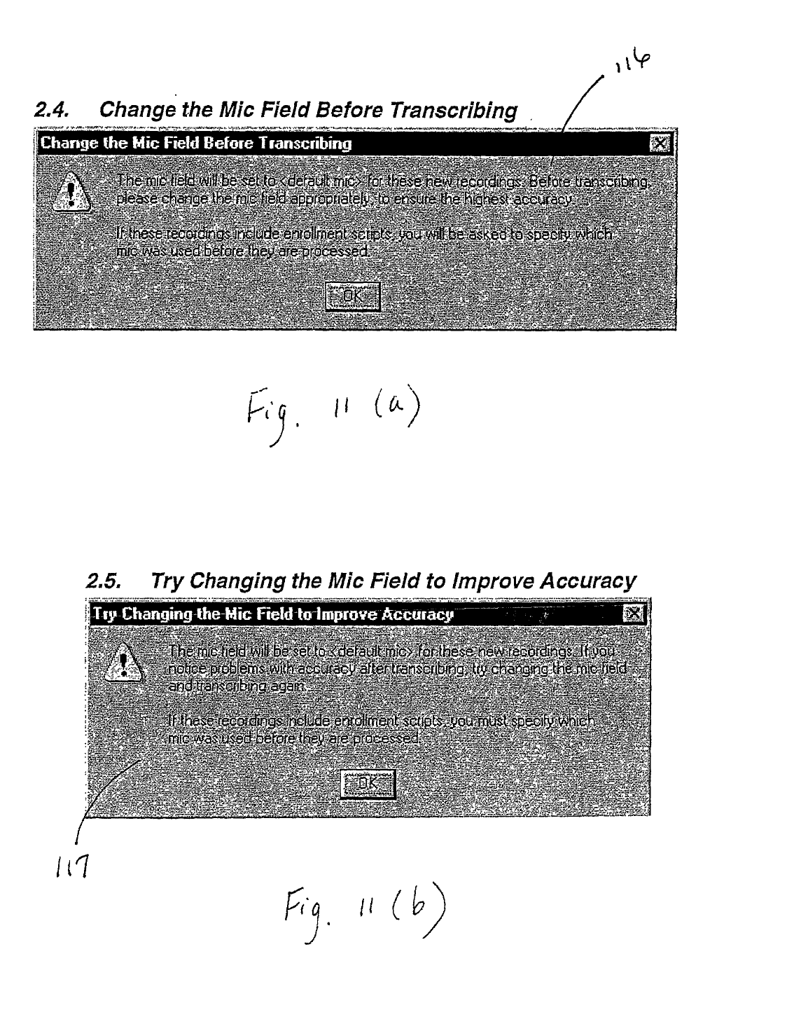

FIGS. 9(a) and 9(b) illustrate display regions of the embodiment of FIG. 8 for notifying a user of the status of a retrieval request. Once a user has specified the audio recorder from which audio files are to be retrieved, the access interface provides a status message 91 to inform the user that the communication module (not shown) is searching for the recorder. If the communication module can not locate the specified audio recorder, a “Recorder Not Found” message 92, appears on the access interface 80 to inform the user that the audio recorder the user would like to access has not been found. The access interface 80 will then display a message 93 suggesting that the user check to see if the audio recorder is still turned on and a message 94 to check if the audio recorder is connected to a parallel port.

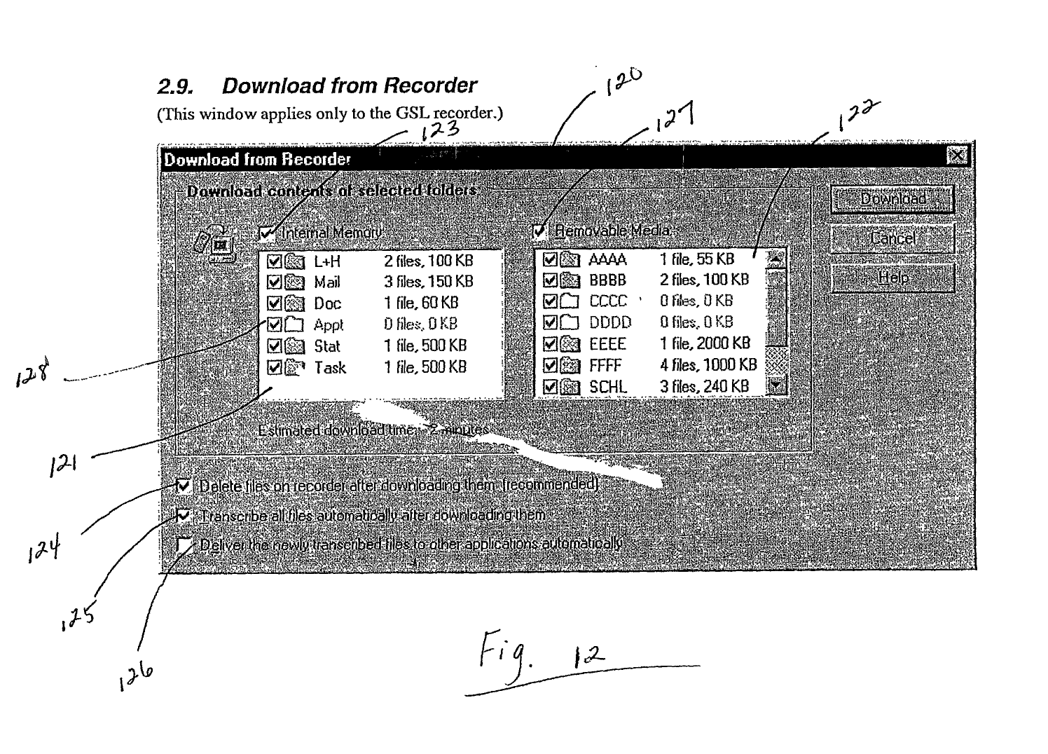

FIG. 10 illustrates a display region of the embodiment of FIG. 8 by which a microphone may be specified. In accordance with this embodiment, the access interface provides a display region 101 whereby a user may specify what type of microphone was used to record an audio file. Knowing what type of microphone was used to record the audio file to be transcribed enables a speech recognition system to transcribe the file more accurately. The user may specify that a headset was used to record all the recordings on the audio recorder by selecting option 102, or that an internal microphone of the audio recorder was used to record all the recordings on the by selecting option 103. Similarly, the user may specify that some of the recordings on the audio recorder where recorded on a headset and others were recorded on an internal microphone by selecting option 104. If the user has forgotten, or does not know what microphone was used, he may specify that he does not know by selecting option 105. The access interface also allows the user to avoid having to specify the microphone each time he wants to transcribe an audio recording if only one type of microphone is ever used by selecting option 106.

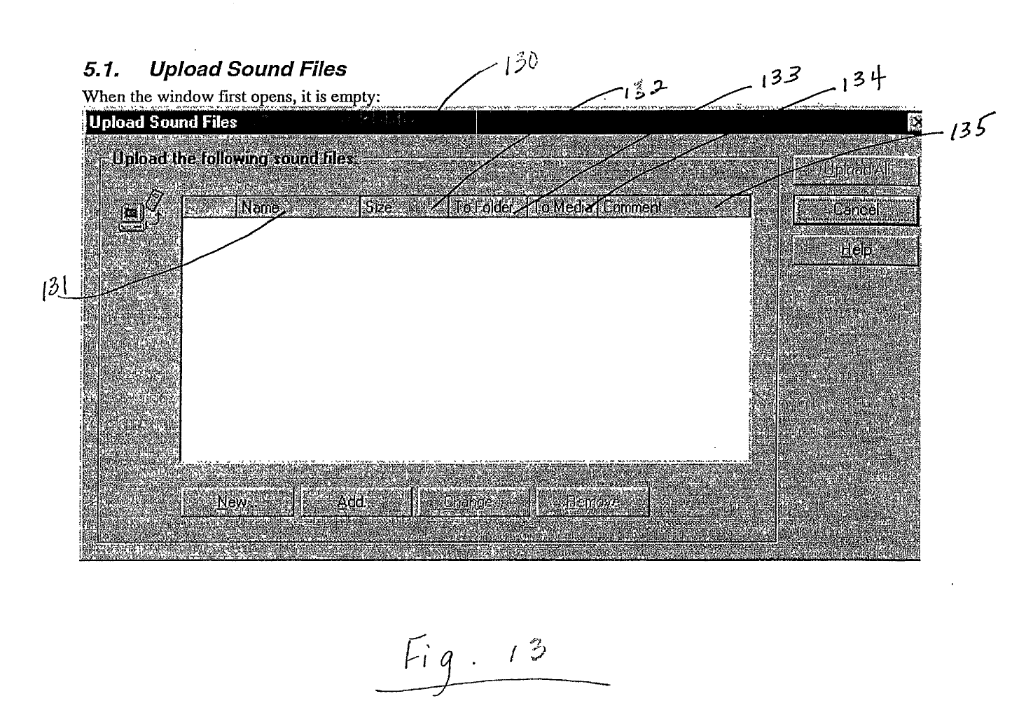

FIGS. 11(a) and (b) illustrate display regions of the embodiment of FIG. 8 that prompt a user to change a microphone field. The access interface also suggests that a microphone field should be changed before transcribing to ensure the highest accuracy. When a user specifies that both a headset and an internal microphone were used to record an audio file (option 104 of FIG. 10), the access interface provides a message 116 to notify the user that a microphone field should be changed. When a user specifies that he does not know what type of microphone was used to record files on the audio recorder (option 105 of FIG. 10), the access interface provides the user with a message 117 that the user should try changing the microphone field to improve the accuracy of a transcription or the accuracy of a download.

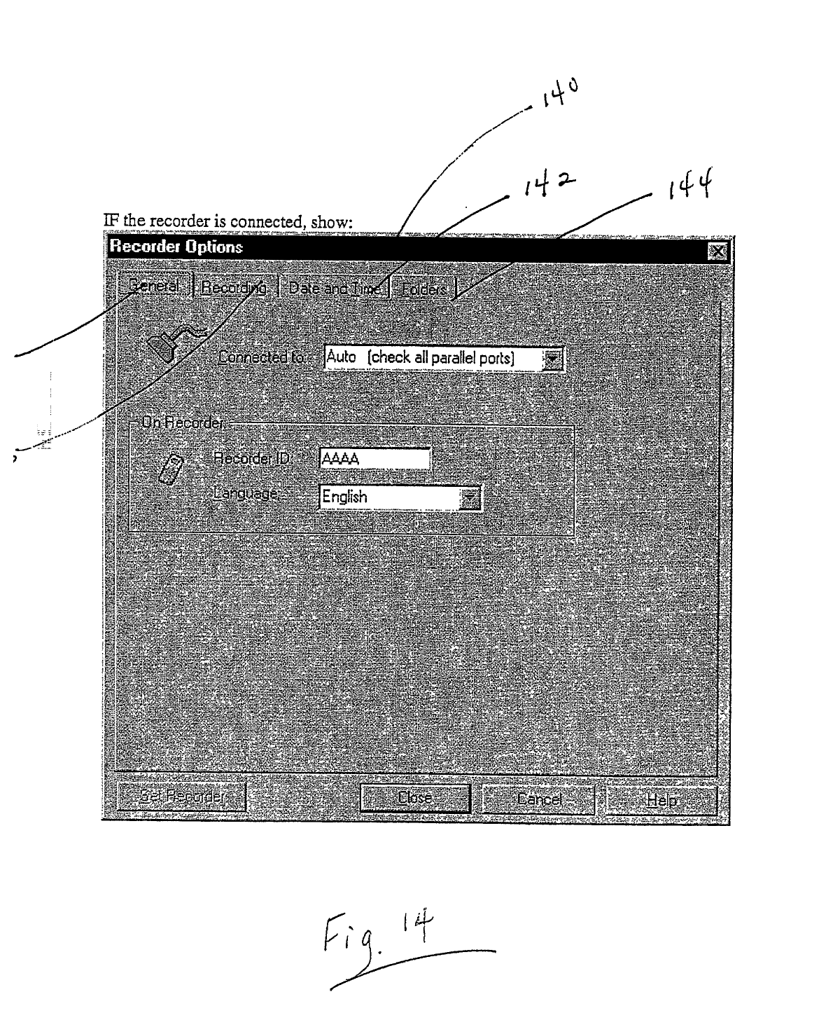

FIG. 12 illustrates a file transfer interface by which files may be downloaded in accordance with another aspect of the present invention. In this embodiment, a file transfer interface 120 enables a user to transfer audio files stored in an audio recorder via a personal computer. The file transfer interface 120 provides a first field 121 for displaying files stored in an internal memory of a the audio recorder, and a second field 122 for displaying files stored in an external memory of the audio recorder. When an internal memory checkbox 123 is checked, all the checkboxes corresponding to the folders in the internal memory are checked. In this manner, a user may opt to delete all the files of the internal memory after downloading by checking a checkbox 124. In addition, a user may opt to transcribe all the files in the internal memory after downloading them by checking another checkbox 125, or the user may opt to deliver the newly transcribed files to another application automatically by checking checkbox 126. When an external memory checkbox 127 is checked, all the checkboxes corresponding to folders in the external memory are checked and the user has similar options as were enumerated with respect to the internal memory. When the internal memory checkbox 123 or external memory checkbox 127 is unchecked, all of the checkboxes corresponding to folders in the memory are unchecked. A user may choose to download and delete, transcribe, or deliver the contents of one folder at a time by checking a checkbox corresponding to the particular folder, such as checkbox 128.

FIG. 13 illustrates a display region of the embodiment of FIG. 12 whereby a file may be uploaded to an audio recorder. The display region 130 contains fields that specify the name of the file to be uploaded 131, the size of the filed to be uploaded 132, the folder in the audio recorder the file should be uploaded to 133, or any other media (such as a personal computer, voice recognition system, or the like) the file should be uploaded to 134. The display region 130 also allows a user to annotate a file to be uploaded by providing a field 135 for user comments.

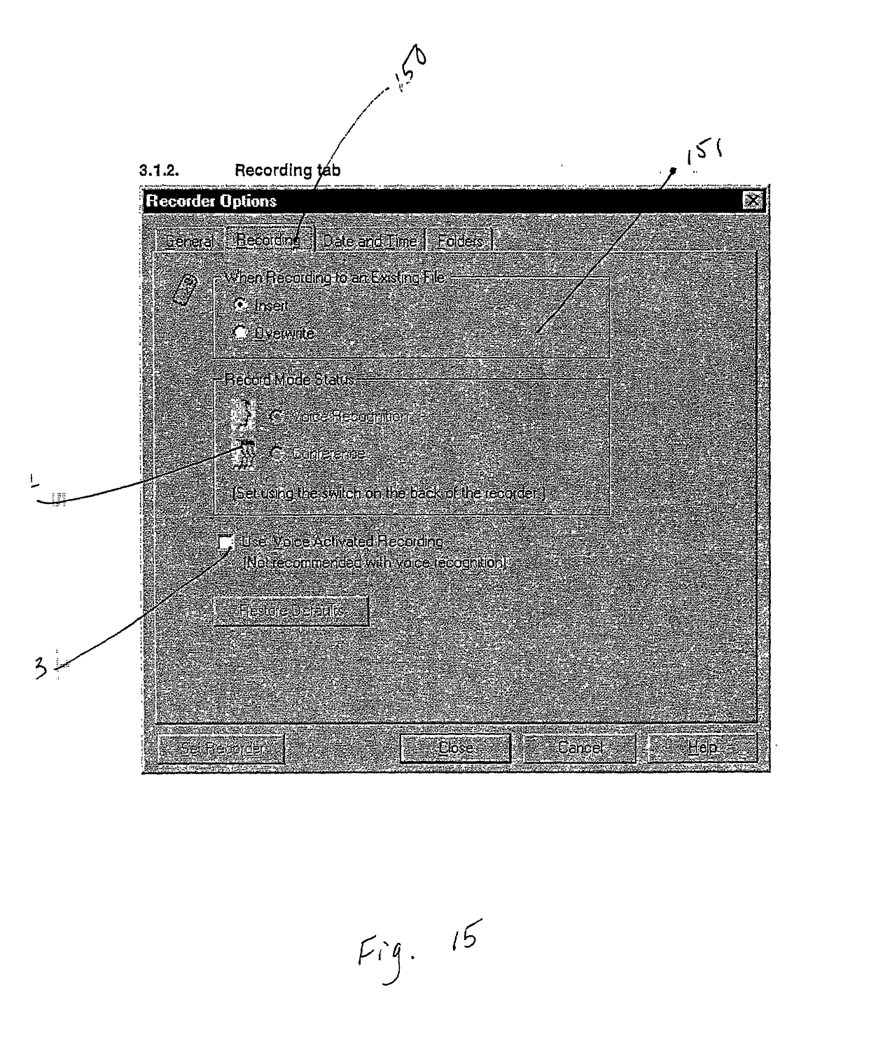

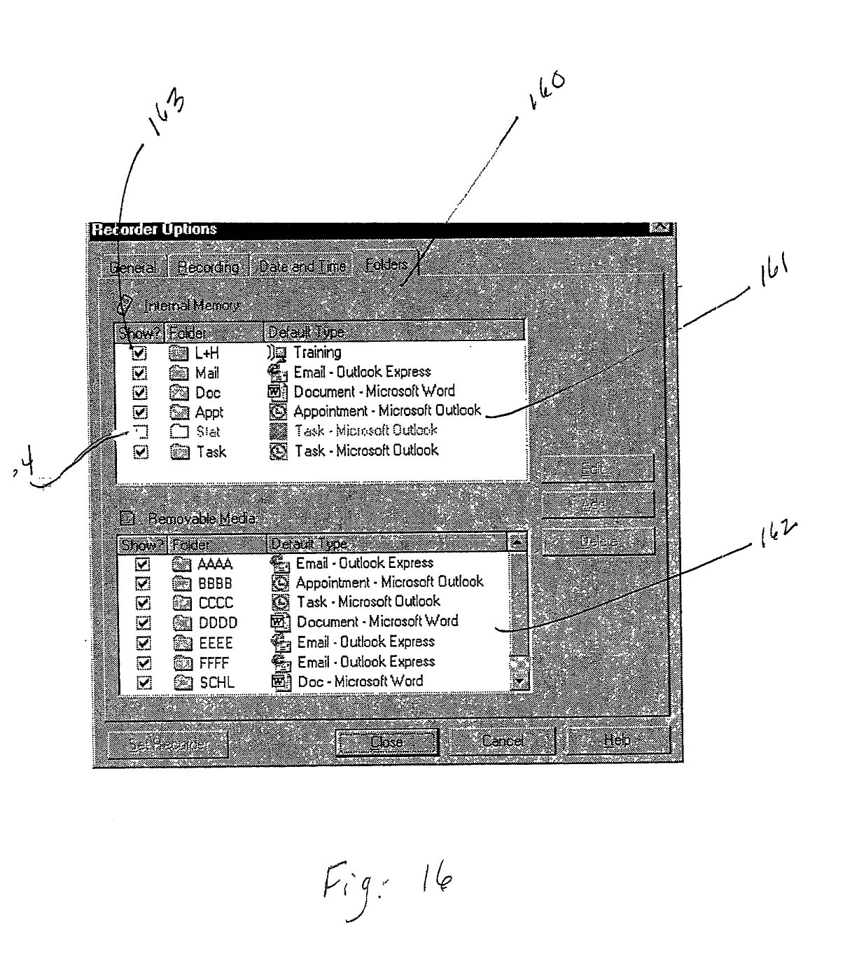

FIG. 14 illustrates a user preference interface by which a user may configure an audio recorder. The user preference interface 140 a includes a display region 141 by which a user may set the language used on the recorder interface display 18, and display region 142 by which a user may set the time and date registered by the audio recorder. The user preference interface 140 further includes a display region 143 for setting recording options, (see FIG. 15) and a display region 144 for managing the folders contained in the audio recorder.

FIG. 15 illustrates a display region of the embodiment of FIG. 14 whereby recording preferences may be specified. The display region 150 provides a field 151 by which a user may choose to insert information into an existing file or overwrite information in an existing file, and a field 152 by which a user may choose a record mode status. The display region 150 also allows a user to use voice activated recording (described above in connection with FIGS. 1-6) by checking a checkbox 153.

FIG. 16 illustrates a display region of the embodiment of FIG. 14 whereby a file in an audio recorder may be concealed. A display region 160 provides a field 161 that enables a user to conceal one or more folders in an internal memory of the audio recorder and a field 162 that enables a user to conceal one or more files or folders in an external memory of the audio recorder. Folders in the internal and external memories have checkboxes corresponding to each folder in a SHOW field 163 of the display region 160. If the user wishes to display the folder on the audio recorder interface display 18 the checkbox will be checked. When a user wishes to conceal a folder in the audio recorder the checkbox corresponding to the folder will unchecked, as is illustrated by checkbox 164. In this way, the folder will be disabled, and access to that folder from the audio recorder will be denied.

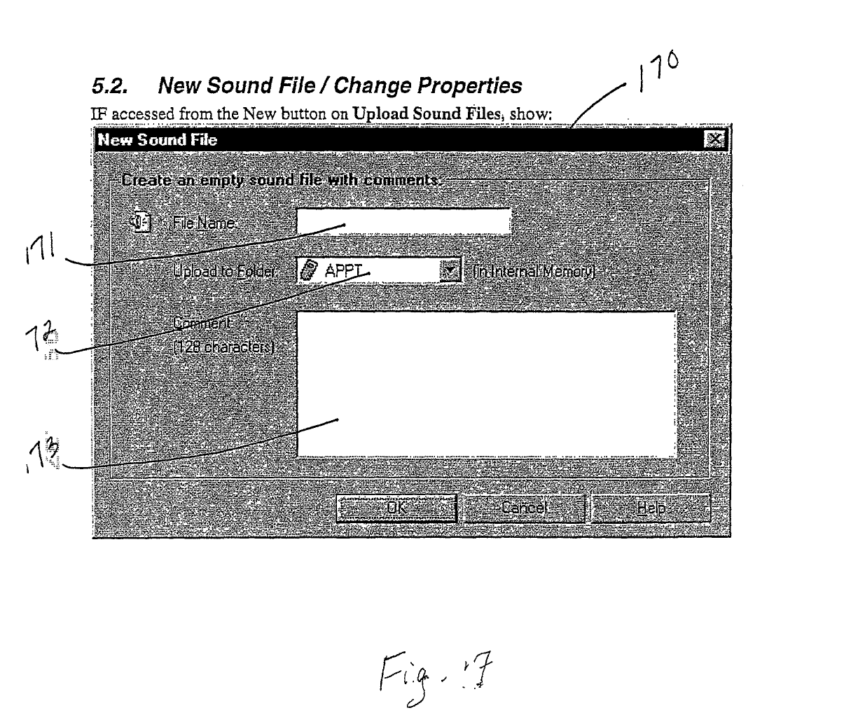

FIG. 17 illustrates a display region of the embodiment of FIG. 14 whereby a file may be created in an audio recorder. A display region 170 provides a field 171 in which a user may specify a name for a new audio file, and another field 172 by which a user may specify a folder in which to store the new audio file. Similarly, field 173 allows a user to input a 128 character comment associated with the new audio file.

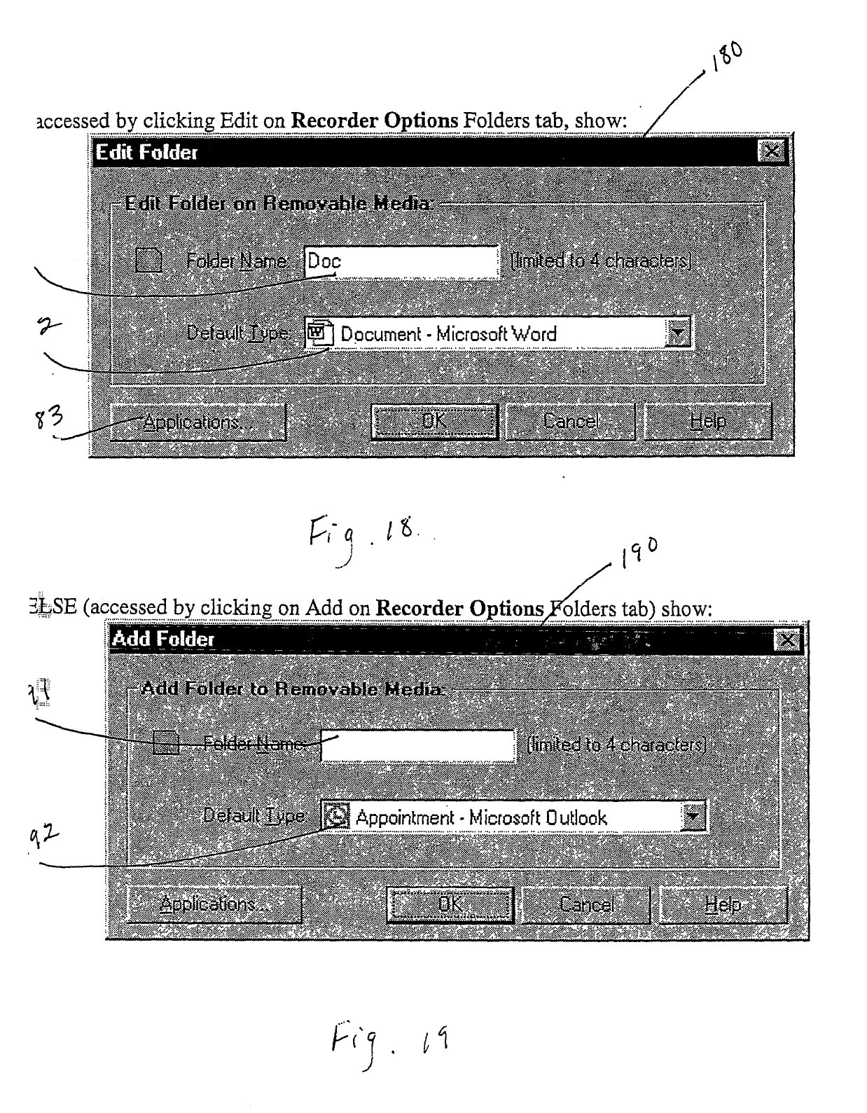

FIG. 18 illustrates a display region of the embodiment of FIG. 14 whereby an audio file may be edited. A display region 180 provides a field 181 in which a user may specify a folder which contains a file to be edited and another field 182 in which the type of file to be edited is specified. The file may be in either an internal or external memory of an audio recorder, and the display region 180 will notify the user as to which memory he is accessing. The user chooses the particular file he wants to edit by way clicking an application button 183.

FIG. 19 illustrates a display region of the embodiment of FIG. 14 whereby an audio file may be added in an audio recorder. As was described with respect to FIG. 18, a display region 190 provides a field 191 in which a user may specify a folder he wants to add to and another field 192 to specify the type of file that is being added. If a folder with the same name already exists in the accessed memory, a popup message will inform the user that a folder with that name already exists.

Although various exemplary embodiments of the invention have been disclosed, it should be apparent to those skilled in the art that various changes and modifications can be made which will achieve some of the advantages of the invention without departing from the true scope of the invention.

What is claimed is:

1. An audio recorder for interfacing with a speech recognition system, the recorder comprising:
a. a microphone having an open front port that senses an audio signal and a closable back port which when open senses an audio signal, the microphone producing an output signal representative of the audio signal sensed by the microphone; and
b. a mode selector switch having:
i. a first position for a close-talking mode in which the back port is open so that audio signals are sensed through both the front port and the back port so as to reduce representation of environmental noise in the output signal, and
ii. a second position for a conference-talking mode in which the back port is closed so that audio signals are sensed through the front port only and environmental noise is not reduced.

2. An audio recorder according to claim 1, wherein the output signal is compressed by the recorder and the second position of the mode selector switch causes greater compression than the first position.

3. An audio recorder according to claim 1, wherein the output signal is amplified by the recorder and the second position of the mode selector switch causes greater amplification than the first position.

4. An audio recorder for interfacing with a speech recognition system, the recorder comprising:
a. a microphone that produces an output signal representative of an input audio signal;
b. a record control that causes the recorder to create a new recording file for storing data representative of the output signal, and to begin storing data in the recording file;
c. a stop control that causes the recorder to stop storing data in the recording file and that ends the recording file; and
d. a recording file memory for storing recording files.

5. An audio recorder according to claim 4, wherein the recording file memory contains at least one file for receiving new vocabulary.

6. An audio recorder according to claim 4, wherein the recording file memory contains a folder for receiving new vocabulary.

7. An audio recorder for interfacing with a speech recognition system, the recorder comprising:
a. an internal microphone that produces an output signal representative of an input audio signal;
b. a jack for an external microphone that disables the internal microphone when an external microphone is plugged into the jack, and that allows the external microphone to produce the output signal representative of the input audio signal;
c. a recording file recorder that stores data representative of the output signal and an indication of the microphone used to produce the output signal.

8. An audio recorder for interfacing with a speech recognition system, the recorder comprising:
a. a recorder housing containing the recorder including a microphone that produces an output signal representative of an input audio signal; and
b. a recorder interface display on the surface of the housing that displays for a user information regarding the current state of the recorder, wherein the language of the information displayed is changeable by the user.

9. An audio recorder according to claim 8, further comprising a speech recognition system interface connection such that the speech recognition system allows the user to change the language of the information displayed.

10. An audio recorder according to claim 8, further comprising an automatic gain control (AGC) circuit that automatically adjusts amplification of the microphone output signal.

11. An audio recorder according to claim 10, wherein the recorder interface display indicates to the user when the audio signal is outside the range of the AGC circuit.

12. An audio recorder according to claim 10, wherein the recorder provides an audible indication to the user when the audio signal is outside the range of the AGC circuit.

13. An audio recorder for interfacing with a speech recognition system, the recorder comprising:
a. a microphone that produces an output signal representative of an input audio signal;
b. a recording file recorder that stores in a recording file data representative of the microphone output signal;
c. an external interface that allows an external recording file containing data representative of an audio signal to be input to the recorder for storage; and
d. a recording file manager that allows a user to store and manage a plurality of recording files in the recorder.

14. An audio recorder according to claim 13, further comprising a recording file player that produces an audible output representative of a user selected recording file.

15. An audio recorder according to claim 14, wherein the recording file player includes a text-to-speech module so that an external recording file may contain text.

16. An audio recorder according to claim 15, wherein an external recording file may be an e-mail message.

17. An audio recorder according to claim 16, wherein a user may audibly respond to the e-mail message via the microphone.

18. An audio recorder according to claim 17, wherein the response may be transcribed to text and attached to the e-mail message.

19. An audio recorder according to claim 15, wherein an external recording file may be an alphanumeric paging message.

20. An audio recorder according to claim 13, wherein the user may record a recording file for insertion into an existing recording file.

21. An audio recorder according to claim 13, wherein the recording file manager allows recording files to be linked together for common processing.

22. A computer user interface that provides access to an audio recorder, the interface comprising:
a. a communication module that generates an access request to a file manager of the audio recorder; and
b. an access interface, coupled to the communication module, the access interface including display regions that specify:
i. an audio recorder that may contain an audio file,
ii. an identity of a speaker who recorded the audio file, and
iii. an acoustic environment in which the audio file was recorded.

23. An interface according to claim 22, wherein the access interface includes a display region to specify the type of microphone used to record an audio file.

24. An interface according to claim 22, wherein the access interface includes a display region to specify a retrieval method for an audio file.

25. An interface according to claim 22, wherein access interface includes a display region that notifies a user of a file transfer status.

26. An interface according to claim 22, wherein the access interface includes a display region that notifies a user that a recorder link is not found.

27. An interface according to claim 26, wherein the access interface includes a display region suggesting actions a user may take when the recorder link is not found.

28. An interface according to claim 22, wherein the access interface includes a display region to change a microphone field before transcribing.

29. An interface according to claim 22, further comprising a file transfer interface coupled to the communication module to transfer files between an audio recorder and a user computer.

30. An interface according to claim 29, wherein the file transfer interface includes a display region to specify that at least one audio file be transferred.

31. An interface according to claim 29, wherein the file transfer interface includes a display region to specify that at least one audio file be transcribed.

32. An interface according to claim 29, wherein the file transfer interface includes a display region to specify that at least one audio file be delivered to a third application.

33. An interface according to claim 29, wherein the file transfer interface includes a display region to specify one of a plurality of delivery methods for a transferred file.

34. An interface according to claim 29, wherein the file transfer interface includes a display region that displays audio files contained in an internal memory of an audio recorder.

35. An interface according to claim 29, wherein the file transfer interface includes a display region that displays audio folders contained in an internal memory of an audio recorder.

36. An interface according to claim 29, wherein the file transfer interface includes a display region that displays audio files contained in an external memory of an audio recorder.

37. An interface according to claim 29, wherein the file transfer interface includes a display region that displays folders contained in an external memory of an audio recorder.

38. An interface according to claim 22, further comprising a user preference interface coupled to the communication module for configuring an audio recorder.

39. An interface according to claim 38, wherein the user preference interface includes an option to conceal at least one audio file or folder.

40. An interface according to claim 38, wherein the user preference interface includes an option to disable at least one empty audio file or folder.

41. An interface according to claim 38, wherein the user preference interface includes an option to edit at least one audio file or folder.

42. An interface according to claim 38, wherein the user preference interface includes an option to add at least one audio file or folder.

43. An interface according to claim 38 wherein the user preference interface includes an option to transcribe an audio file or folder.

44. An interface according to claim 38, wherein the user preference interface includes an option to transcribe an audio file with vocal annotations.

45. An interface according to claim 38, wherein the user preference interface includes a display region to specify a language in which menus are displayed on the audio recorder.

46. An interface according to claim 38, wherein the user preference interface includes an option to combine audio files.

47. An interface according to claim 38, wherein the user preference interface includes an option to annotate an audio file.

48. An interface according to claim 38, wherein the user preference interface includes an option to create at least one audio file in an audio recorder.

49. An interface according to claim 38, wherein the user preference interface includes an option to compress an audio file.

50. A system for managing audio files on an audio recorder, the system comprising:
a. an audio recorder to record an audio file;
b. a communication module that generates an access request to a file manager of the audio recorder; and
c. an access interface, coupled to the communication module, the access interface including display regions that specify:
i. an audio recorder that may contain an audio file
ii. an identity of a speaker who recorded the audio file, and
iii. an acoustic environment in which the audio file was recorded.

51. A system according to claim 50, wherein the audio recorder comprises:
a. a microphone having an open front port that senses an audio signal and a closable back port which when open senses an audio signal, the microphone producing an output signal representative of the audio signal sensed by the microphone; and
b. a mode selector switch having:
i. a first position for a close-talking mode in which the back port is open so that audio signals are sensed through both the front port and the back port so as to reduce representation of environmental noise in the output signal, and
ii. a second position for a conference-talking mode in which the back port is closed so that audio signals are sensed through the front port only and environmental noise is not reduced.

52. A system according to claim 50, further comprising a file transfer interface coupled to the communication module to transfer files between the audio recorder and a user computer.

53. A system according to claim 50, further comprising a user preference interface coupled to the communication module for configuring an audio recorder.
